(19) United States
(12) Patent Application Publication
(10) Pub. No.: US 2009/0094509 A1
(43) Pub. Date: Apr. 9, 2009

(54) DOCUMENT PROCESSING DEVICE, AND DOCUMENT PROCESSING METHOD

(75) Inventor: Masakazu Hironiwa, Tokushima (JP)

Correspondence Address: SUGHRUE MION, PLLC, 2100 PENNSYLVANIA AVENUE, N.W., SUITE 800, WASHINGTON, DC, 20037, US

(73) Assignee: JUSTSYSTEMS CORPORATION, Tokushima-shi, Tokushima (JP)

(21) Appl. No.: 11/913,468

(22) PCT Filed: May 1, 2006
(86) PCT No.: PCT/JP2006/309104

§ 371 Date: Nov. 2, 2007

(30) Foreign Application Priority Data
May 2, 2005 (JP) 2005-134070

(51) Int. Cl. G06F 17/00

(52) U.S. Cl. 715/234

(57) ABSTRACT

A technology is provided in which a document described in a markup language is appropriately processed. In the document processing apparatus, when the definition file creating unit creates a new definition file, the definition file name creating unit creates a name of the definition file. When the document acquisition unit acquires a document, the namespace URI reference acquisition unit acquires a namespace URI reference of a vocabulary which is a tag set to which an element included in an XML document belongs. The definition file name creating unit creates a name of a definition file by computing a hash value of the namespace URI reference. The definition file acquisition unit acquires a definition file of which name is created by the definition file name creating unit. When the definition file is acquired, an element included in the document is mapped to an element of an XHTML vocabulary, for example, by the mapping unit, thereby the element being displayed and edited by the HTML unit or the like.

### FIELD OF THE INVENTION

The present invention relates to a document processing technology, in particular, to a document processing apparatus and method which process a document described in a markup language.

### BACKGROUND OF THE INVENTION

XML attracts attention as a form suitable for sharing data with others via a network etc., and applications for creating, displaying and editing XML documents are developed (for example, see Patent Document 1). An XML document is created based on a vocabulary (tag set) defined by document type definition etc.

Patent documents 1: Japanese Patent application Laid-open Publication No. 2001-290804.

### DISCLOSURE OF THE INVENTION

### Problems to be Solved by the Invention

Any vocabulary can be defined freely, therefore infinitely many vocabularies could be available theoretically. It is not realistic to provide a dedicated environment for displaying and editing any one of these vocabularies. However, even for a local vocabulary which a small number of users use, a method for improving convenience in editing the vocabulary is needed.

The present invention is made in view of these circumstances, and a general purpose of the invention is to provide a technology in which a document described in a markup language is appropriately processed.

### Means for Solving the Problem

An embodiment of the present invention relates to a document processing apparatus. The document processing apparatus includes an identifier acquisition unit which acquires an identifier for identifying a tag set to which an element included in a document belongs; and a file name creating unit which creates a name of a file to be associated with the document based on the identifier. By implementing such a structure, a file to be associated with the document, for example, a definition file to be applied to the document, in which a method for processing the document is described, can be appropriately identified, even if the name of the definition file is not specified explicitly. Furthermore, because a tag set to be a processing target and a name of a file are coupled with each other, the possibility of applying a wrong definition file can be reduced. A tag set may be a vocabulary of XML and an identifier may be a namespace URI reference.

The document processing apparatus may further include a document acquisition unit which acquires the document and a definition file acquisition unit which acquires the definition file, wherein the identifier acquisition unit may acquire an identifier described in a document which the document acquisition unit acquires, and the definition file acquisition unit may acquire a definition file of which name is created by the file name creating unit based on the identifier.

The document processing apparatus may further include a definition file creating unit which creates the definition file, wherein the definition file creating unit may give a name to the definition file created, a name created by the file name creating unit based on an identifier for identifying a tag set to which an element which is processed by the definition file belongs.

The file name creating unit may create a name of the definition file based on a hash value obtained by converting the identifier with the use of a hash function.

Note that any combination of the aforementioned components or any manifestation of the present invention exchanged between methods, devices, systems and so forth, is effective as an embodiment of the present invention.

### ADVANTAGE OF THE INVENTION

According to the present invention, a technology can be provided in which a document described in a markup language is appropriately processed.

### BRIEF DESCRIPTION OF THE DRAWINGS

FIG. 1 is a diagram which shows a structure of a document processing apparatus according to the base technology;

FIG. 2 is a diagram which shows an example of an XML document edited by the document processing apparatus;

FIG. 3 is a diagram which shows an example in which the XML document shown in FIG. 2 is mapped to a table described in HTML;

FIG. 4(a) is a diagram which shows an example of a definition file used for mapping the XML document shown in FIG. 2 to the table shown in FIG. 3;

FIG. 4(b) is a diagram which shows an example of a definition file used for mapping the XML document shown in FIG. 2 to the table shown in FIG. 3;

FIG. 5 is a diagram which shows an example of a screen on which the XML document shown in FIG. 2 is displayed after having been mapped to HTML in accordance with the correspondence shown in FIG. 3;

FIG. 6 is a diagram which shows an example of a graphical user interface provided by a definition file creating unit, which allows the user to create a definition file;

FIG. 7 is a diagram which shows another example of a screen layout created by the definition file creating unit;

FIG. 8 is a diagram which shows an example of an editing screen on which an XML document is edited by the document processing apparatus;

FIG. 9 is a diagram which shows another example of an XML document which is edited by the document processing apparatus;

FIG. 10 is a diagram which shows an example of a screen on which the document shown in FIG. 9 is displayed;

FIG. 11 is a diagram which shows a structure of the document processing apparatus according to the embodiment.

### REFERENCE NUMERALS

20 document processing apparatus
22 main control unit
24 editing unit
30 DOM unit
32 DOM provider
34 DOM builder
36 DOM writer
40 CSS unit
42 CSS parser
44 CSS provider
46 rendering unit
50 HTML unit
52, 62 control unit
54, 64 editing unit
56, 66 display unit
60 SVG unit
72 document acquisition unit
74 namespace URI reference acquisition unit
76 definition file name creating unit
80 VC unit
82 mapping unit
84 definition file acquisition unit
86 definition file creating unit

### BEST MODE FOR CARRYING OUT THE INVENTION

### Base Technology

illustrates a structure of a document processing apparatus 20 according to Base Technology. The document processing apparatus 20 processes a structured document where data in the document are classified into a plurality of components having a hierarchical structure. Represented in Base Technology is an example in which an XML document, as one type of a structured document, is processed. The document processing apparatus 20 is comprised of a main control unit 22, an editing unit 24, a DOM unit 30, a CSS unit 40, an HTML unit 50, an SVG unit 60 and a VC unit 80 which serves as an example of a conversion unit. In terms of hardware components, these unit structures may be realized by any conventional processing system or equipment, including a CPU or memory of any computer, a memory-loaded program, or the like. Here, the drawing shows a functional block configuration which is realized by cooperation between the hardware components and software components. Thus, it should be understood by a person skilled in the art that these functional blocks can be realized in a variety of forms by hardware only, software only or the combination thereof.

The main control unit 22 provides for the loading of a plug-in or a framework for executing a command. The editing unit 24 provides a framework for editing XML documents. Display and editing functions for a document in the document processing apparatus 20 are realized by plug-ins, and the necessary plug-ins are loaded by the main control unit 22 or the editing unit 24 according to the type of document under consideration. The main control unit 22 or the editing unit 24 determines which vocabulary or vocabularies describes the content of an XML document to be processed, by referring to a name space of the document to be processed, and loads a plug-in for display or editing corresponding to the thus determined vocabulary so as to execute the display or the editing. For instance, an HTML unit 50, which displays and edits HTML documents, and an SVG unit 60, which displays and edits SVG documents, are implemented in the document processing apparatus 20. That is, a display system and an editing system are implemented as plug-ins for each vocabulary (tag set), so that when an HTML document and an SVG document are edited, HTML unit 50 and the SVG unit 60 are loaded, respectively. As will be described later, when compound documents, which contain both HTML and SVG components, are to be processed, both HTML unit 50 and the SVG unit 60 are loaded.

By implementing the above structure, a user can select so as to install only necessary functions, and can add or delete a function or functions at a later stage, as appropriately. Thus, the storage area of a recording medium, such as a hard disk, can be effectively utilized, and the wasteful use of memory can be prevented at the time of executing programs. Furthermore, since the capability of this structure is highly expandable, a developer can deal with new vocabularies in the form of plug-ins, and thus the development process can be readily facilitated. As a result, the user can also add a function or functions easily at low cost by adding a plug-in or plug-ins.

The editing unit 24 receives an event, which is an editing instruction, from the user via the user interface. Upon reception of such an event, the editing unit 24 notifies a suitable plug-in or the like of this event, and controls the processing such as redoing this event, canceling (undoing) this event, etc.

The DOM unit 30 includes a DOM provider 32, a DOM builder 34 and a DOM writer 36. The DOM unit 30 realizes functions in compliance with a document object model (DOM), which is defined to provide an access method used for handling data in the form of an XML document. The DOM provider 32 is an implementation of a DOM that satisfies an interface defined by the editing unit 24. The DOM builder 34 creates DOM trees from XML documents. As will be described later, when an XML document to be processed is mapped to another vocabulary by the VC unit 80, a source tree, which corresponds to the XML document in a mapping source, and a destination tree, which corresponds to the XML document in a mapping destination, are created. At the end of editing, for example, the DOM writer 36 outputs a DOM tree as an XML document.

The CSS unit 40, which provides a display function conforming to CSS, includes a CSS parser 42, a CSS provider 44 and a rendering unit 46. The CSS parser 42 has a parsing function for analyzing the CSS syntax. The CSS provider 44 is an implementation of a CSS object and performs CSS cascade processing on the DOM tree. The rendering unit 46 is a CSS rendering engine and is used to display documents, described in a vocabulary such as HTML, which are laid out using CSS.

HTML unit 50 displays or edits documents described in HTML. The SVG unit 60 displays or edits documents described in SVG. These display/editing systems are realized in the form of plug-ins, and each system is comprised of a display unit (also designated herein as a “canvas”) 56 and 66, which displays documents, a control unit (also designated herein as an “editlet”) 52 and 62, which transmits and receives events containing editing commands, and an edit unit (also designated herein as a “zone”) 54 and 64, which edits the DOM according to the editing commands. Upon the control unit 52 or 62 receiving a DOM tree editing command from an external source, the edit unit 54 or 64 modifies the DOM tree and the display unit 56 or 66 updates the display. These units have a structure similar to the framework of the so-called MVC (Model-View-Controller). With such a structure, in general, the display units 56 and 66 correspond to “View”. On the other hand, the control units 52 and 62 correspond to “Controller”, and the edit units 54 and 64 and DOM instance corresponds to “Model”. The document processing apparatus 20 according to the Base Technology allows an XML document to be edited according to each given vocabulary, as well as providing a function of editing HTML document in the form of tree display. HTML unit 50 provides a user interface for editing an HTML document in a manner similar to a word processor, for example. On the other hand, the SVG unit 60 provides a user interface for editing an SVG document in a manner similar to an image drawing tool.

The VC unit 80 includes a mapping unit 82, a definition file acquiring unit 84 and a definition file generator 86. The VC unit 80 performs mapping of a document, which has been described in a particular vocabulary, to another given vocabulary, thereby providing a framework that allows a document to be displayed and edited by a display/editing plug-in corresponding to the vocabulary to which the document is mapped. In the Base Technology, this function is called a vocabulary connection (VC) In the VC unit 80, the definition file acquiring unit 84 acquires a script file in which the mapping definition is described. Here, the definition file specifies the correspondence (connection) between the Nodes for each Node. Furthermore, the definition file may specify whether or not editing of the element values or attribute values is permitted. Furthermore, the definition file may include operation expressions using the element values or attribute values for the Node. Detailed description will be made later regarding these functions. The mapping unit 82 instructs the DOM builder 34 to create a destination tree with reference to the script file acquired by the definition file acquiring unit 84. This manages the correspondence between the source tree and the destination tree. The definition file generator 86 offers a graphical user interface which allows the user to create a definition file.

The VC unit 80 monitors the connection between the source tree and the destination tree. Upon reception of an editing instruction from the user via a user interface provided by a plug-in that handles a display function, the VC unit 80 first modifies a relevant Node of the source tree. As a result, the DOM unit 30 issues a mutation event indicating that the source tree has been modified. Upon reception of the mutation event thus issued, the VC unit 80 modifies a Node of the destination tree corresponding to the modified Node, thereby updating the destination tree in a manner that synchronizes with the modification of the source tree. Upon reception of a mutation event that indicates that the destination tree has been modified, a plug-in having functions of displaying/editing the destination tree, e.g., HTML unit 50, updates a display with reference to the destination tree thus modified. Such a structure allows a document described in any vocabulary, even a minor vocabulary used in a minor user segment, to be converted into a document described in another major vocabulary. This enables such a document described in a minor vocabulary to be displayed, and provides an editing environment for such a document.

An operation in which the document processing apparatus 20 displays and/or edits documents will be described herein below. When the document processing apparatus 20 loads a document to be processed, the DOM builder 34 creates a DOM tree from the XML document. The main control unit 22 or the editing unit 24 determines which vocabulary describes the XML document by referring to a name space of the XML document to be processed. If the plug-in corresponding to the vocabulary is installed in the document processing apparatus 20, the plug-in is loaded so as to display/edit the document. If, on the other hand, the plug-in is not installed in the document processing apparatus 20, a check shall be made to see whether a mapping definition file exists or not. And if the definition file exits, the definition file acquiring unit 84 acquires the definition file and creates a destination tree according to the definition, so that the document is displayed/edited by the plug-in corresponding to the vocabulary which is to be used for mapping. If the document is a compound document containing a plurality of vocabularies, relevant portions of the document are displayed/edited by plug-ins corresponding to the respective vocabularies, as will be described later. If the definition file does not exist, a source or tree structure of a document is displayed and the editing is carried out on the display screen.

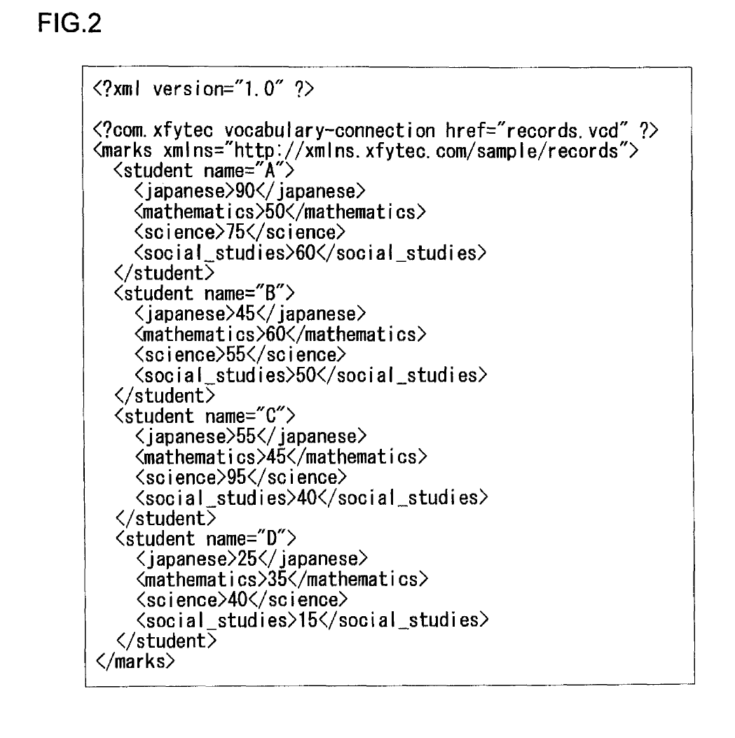

FIG. 2 shows an example of an XML document to be processed. According to this exemplary illustration, the XML document is used to manage data concerning grades or marks that students have earned. A component “marks”, which is the top Node of the XML document, includes a plurality of components “student” provided for each student under “marks”. The component “student” has an attribute “name” and contains, as child elements, the subjects “japanese”, “mathematics”, “science”, and “social_studies”. The attribute “name” stores the name of a student. The components “japanese”, “mathematics”, “science” and “social_studies” store the test scores for the subjects Japanese, mathematics, science, and social studies, respectively. For example, the marks of a student whose name is “A” are “90” for Japanese, “50” for mathematics, “75” for science and “60” for social studies. Hereinafter, the vocabulary (tag set) used in this document will be called “marks managing vocabulary”.

Here, the document processing apparatus 20 according to the Base Technology does not have a plug-in which conforms to or handles the display/editing of marks managing vocabularies. Accordingly, before displaying such a document in a manner other than the source display manner or the tree display manner, the above-described VC function is used. That is, there is a need to prepare a definition file for mapping the document, which has been described in the marks managing vocabulary, to another vocabulary, which is supported by a corresponding plug-in, e.g., HTML or SVG. Note that description will be made later regarding a user interface that allows the user to create the user's own definition file. Now, description will be made below regarding a case in which a definition file has already been prepared.

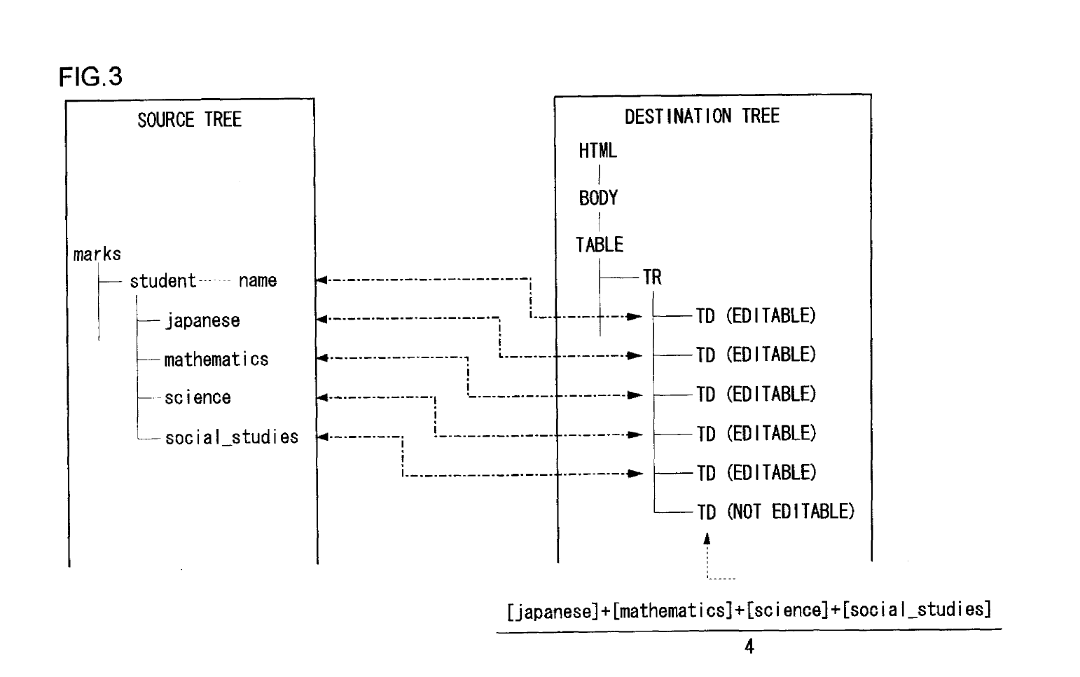

FIG. 3 shows an example in which the XML document shown in FIG. 2 is mapped to a table described in HTML. In an example shown in FIG. 3, a “student” Node in the marks managing vocabulary is associated with a row (“TR” Node) of a table (“TABLE” Node) in HTML. The first column in each row corresponds to an attribute value “name”, the second column to a “japanese” Node element value, the third column to a “mathematics” Node element value, the fourth column to a “science” Node element value and the fifth column to a “social_studies” Node element value. As a result, the XML document shown in FIG. 2 can be displayed in an HTML tabular format. Furthermore, these attribute values and element values are designated as being editable, so that the user can edit these values on a display screen using an editing function of HTML unit 50. In the sixth column, an operation expression is designated for calculating a weighted average of the marks for Japanese, mathematics, science and social studies, and average values of the marks for each student are displayed. In this manner, more flexible display can be effected by making it possible to specify the operation expression in the definition file, thus improving the users' convenience at the time of editing. In this example shown in FIG. 3, editing is designated as not being possible in the sixth column, so that the average value alone cannot be edited individually. Thus, in the mapping definition it is possible to specify editing or no editing so as to protect the users against the possibility of performing erroneous operations.

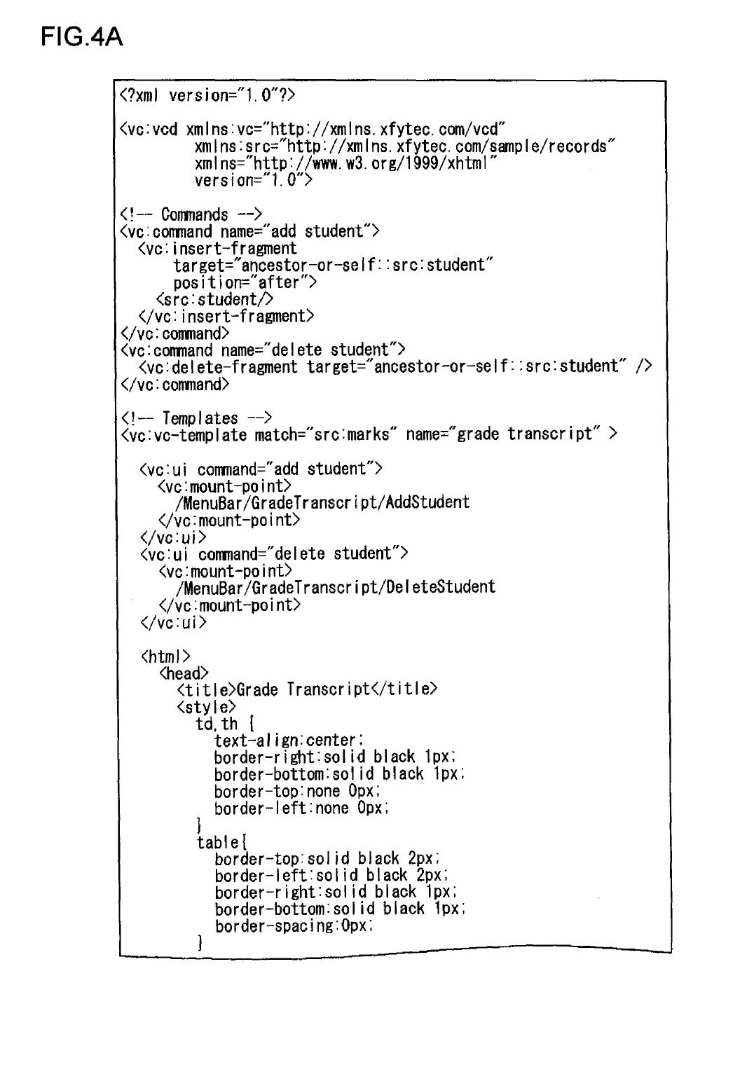

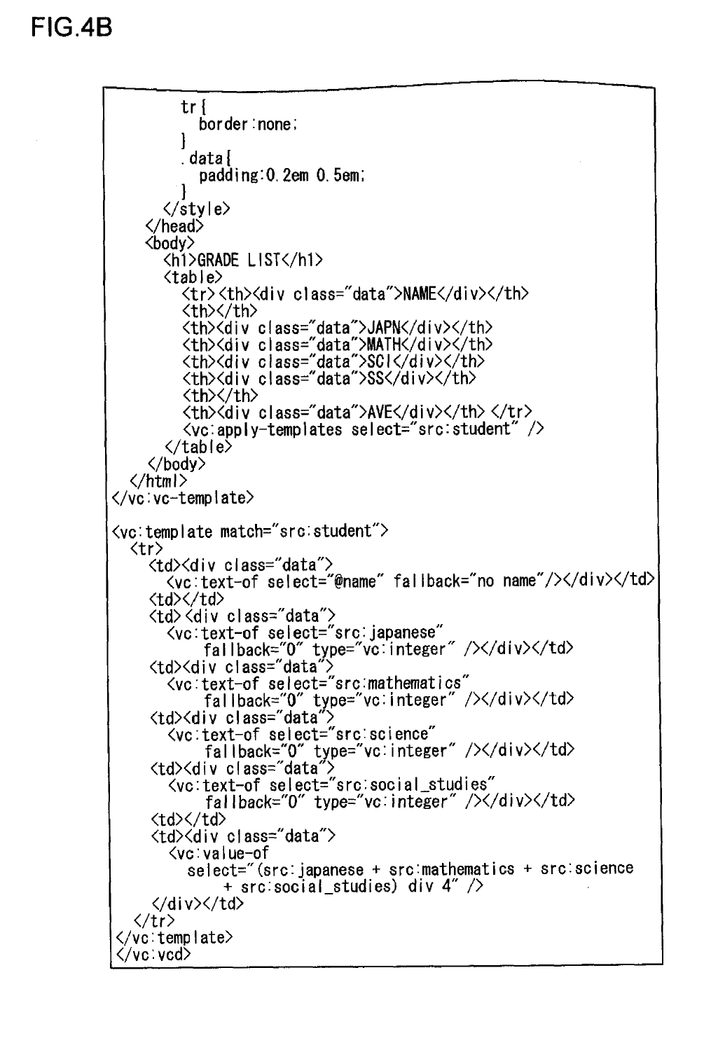

FIG. 4(a) and FIG. 4(b) illustrate an example of a definition file to map the XML document shown in FIG. 2 to the table shown in FIG. 3. This definition file is described in script language defined for use with definition files. In the definition file, definitions of commands and templates for display are described. In the example shown in FIG. 4(a) and FIG. 4(b), “add student” and “delete student” are defined as commands, and an operation of inserting a Node “student” into a source tree and an operation of deleting the Node “student” from the source tree, respectively, are associated with these commands. Furthermore, the definition file is described in the form of a template, which describes that a header, such as “name” and “japanese”, is displayed in the first row of a table and the contents of the Node “student” are displayed in the second and subsequent rows. In the template displaying the contents of the Node “student”, a term containing “text-of” indicates that editing is permitted, whereas a term containing “value-of” indicates that editing is not permitted. Among the rows where the contents of the Node “student” are displayed, an operation expression “(src:japanese+src:mathematics+scr:science+scr:social_studies) div 4” is described in the sixth row. This means that the average of the student's marks is displayed.

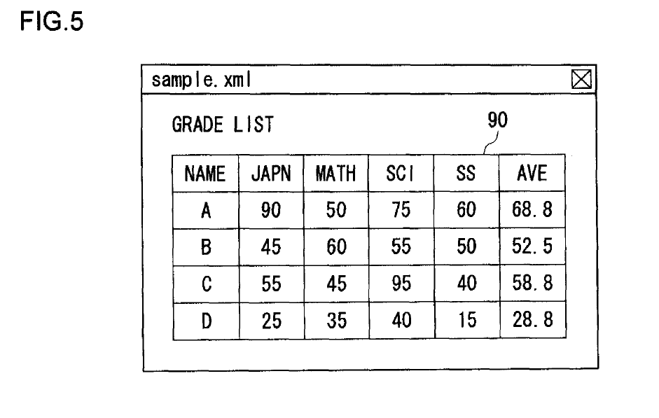

FIG. 5 shows an example of a display screen on which an XML document described in the marks managing vocabulary shown in FIG. 2 is displayed by mapping the XML document to HTML using the correspondence shown in FIG. 3. Displayed from left to right in each row of a table 90 are the names of each student, marks for Japanese, marks for mathematics, marks for science, marks for social studies and the averages thereof. The user can edit the XML document on this screen. For example, when the value in the second row and the third column is changed to “70”, the element value in the source tree corresponding to this Node, that is, the marks of student “B” for mathematics are changed to “70”. At this time, in order to have the destination tree follow the source tree, the VC unit 80 changes a relevant portion of the destination tree accordingly, so that HTML unit 50 updates the display based on the destination tree thus changed. Hence, the marks of student “B” for mathematics are changed to “70”, and the average is changed to “55” in the table on the screen.

On the screen as shown in FIG. 5, commands like “add student” and “delete student” are displayed in a menu as defined in the definition file shown in FIG. 4(a) and FIG. 4(b). When the user selects a command from among these commands, a Node “student” is added or deleted in the source tree. In this manner, with the document processing apparatus 20 according to the Base Technology, it is possible not only to edit the element values of components in a lower end of a hierarchical structure but also to edit the hierarchical structure. An edit function for editing such a tree structure may be presented to the user in the form of commands. Furthermore, a command to add or delete rows of a table may, for example, be linked to an operation of adding or deleting the Node “student”. A command to embed other vocabularies therein may be presented to the user. This table may be used as an input template, so that marks data for new students can be added in a fill-in-the-blank format. As described above, the VC function allows a document described in the marks managing vocabulary to be edited using the display/editing function of HTML unit 50.

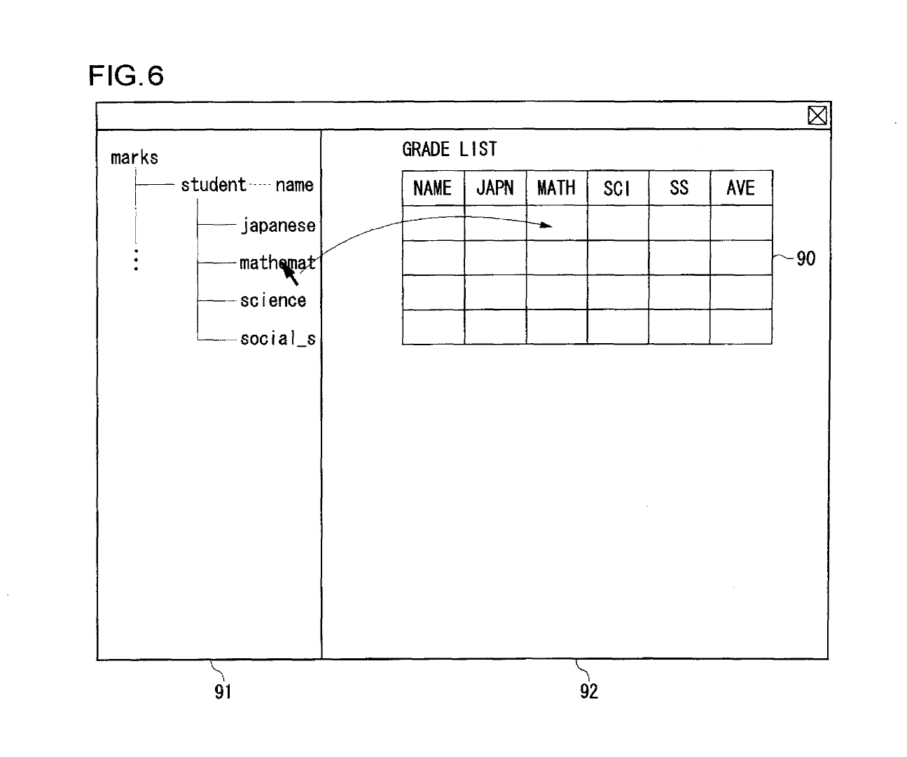

FIG. 6 shows an example of a graphical user interface, which the definition file generator 86 presents to the user, in command for the user to create a definition file. An XML document to be mapped is displayed in a tree in a left-hand area 91 of a screen. The screen layout of an XML document after mapping is displayed in a right-hand area 92 of the screen. This screen layout can be edited by HTML unit 50, and the user creates a screen layout for displaying documents in the right-hand area 92 of the screen. For example, a Node of the XML document which is to be mapped, which is displayed in the left-hand area 91 of the screen, is dragged and dropped into HTML screen layout in the right-hand area 92 of the screen using a pointing device such as a mouse, so that a connection between a Node at a mapping source and a Node at a mapping destination is specified. For example, when “mathematics,” which is a child element of the element “student,” is dropped to the intersection of the first row and the third column in a table 90 on HTML screen, a connection is established between the “mathematics” Node and a “TD” Node in the third column. Either editing or no editing can be specified for each Node. Moreover, the operation expression can be embedded in a display screen. When the screen editing is completed, the definition file generator 86 creates definition files, which describe connections between the screen layout and Nodes.

Viewers or editors which can handle major vocabularies such as XHTML, MathML and SVG have already been developed. However, it does not serve any practical purpose to develop dedicated viewers or editors for such documents described in the original vocabularies as shown in FIG. 2. If, however, the definition files for mapping to other vocabularies are created as mentioned above, the documents described in the original vocabularies can be displayed and/or edited utilizing the VC function without the need to develop a new viewer or editor.

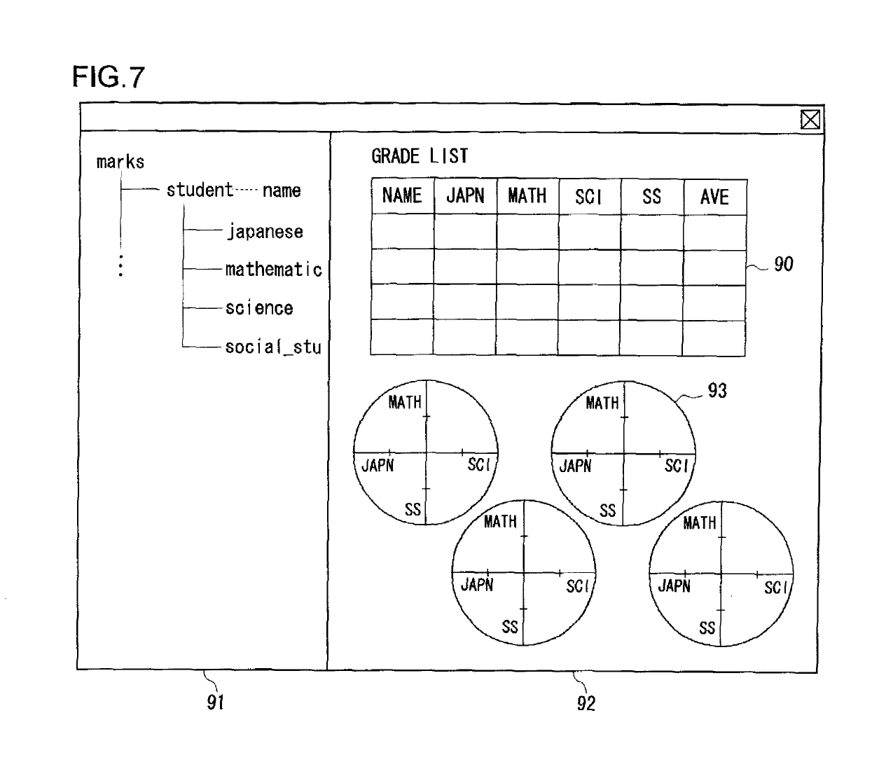

FIG. 7 shows another example of a screen layout created by the definition file generator 86. In the example shown in FIG. 7, a table 90 and circular graphs 93 are created on a screen for displaying XML documents described in the marks managing vocabulary. The circular graphs 93 are described in SVG. As will be discussed later, the document processing apparatus 20 according to the Base Technology can process a compound document described in the form of a single XML document according to a plurality of vocabularies. That is why the table 90 described in HTML and the circular graphs 93 described in SVG can be displayed on the same screen.

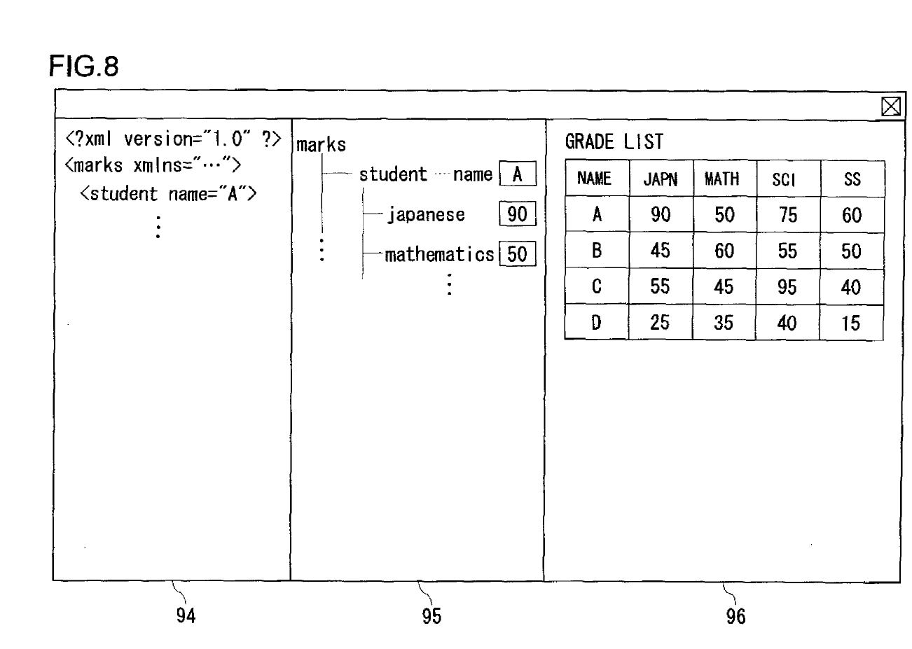

FIG. 8 shows an example of a display medium, which in a preferred but non-limiting embodiment is an edit screen, for XML documents processed by the document processing apparatus 20. In the example shown in FIG. 8, a single screen is partitioned into a plurality of areas and the XML document to be processed is displayed in a plurality of different display formats at the respective areas. The source of the document is displayed in an area 94, the tree structure of the document is displayed in an area 95, and the table shown in FIG. 5 and described in HTML is displayed in an area 96. The document can be edited in any of these areas, and when the user edits content in any of these areas, the source tree will be modified accordingly, and then each plug-in that handles the corresponding screen display updates the screen so as to effect the modification of the source tree. Specifically, display units of the plug-ins in charge of displaying the respective edit screens are registered in advance as listeners for mutation events that provide notice of a change in the source tree. When the source tree is modified by any of the plug-ins or the VC unit 80, all the display units, which are displaying the edit screen, receive the issued mutation event (s) and then update the screens. At this time, if the plug-in is executing the display through the VC function, the VC unit 80 modifies the destination tree following the modification of the source tree. Thereafter, the display unit of the plug-in modifies the screen by referring to the destination tree thus modified.

For example, when the source display and tree-view display are implemented by dedicated plug-ins, the source-display plug-in and the tree-display plug-in execute their respective displays by directly referring to the source tree without involving the destination tree. In this case, when the editing is done in any area of the screen, the source-display plug-in and the tree-display plug-in update the screen by referring to the modified source tree. Also, HTML unit 50 in charge of displaying the area 96 updates the screen by referring to the destination tree, which has been modified following the modification of the source tree.

The source display and the tree-view display can also be realized by utilizing the VC function. That is to say, an arrangement may be made in which the source and the tree structure are laid out in HTML, an XML document is mapped to HTML structure thus laid out, and HTML unit 50 displays the XML document thus mapped. In such an arrangement, three destination trees in the source format, the tree format and the table format are created. If the editing is carried out in any of the three areas on the screen, the VC unit 80 modifies the source tree and, thereafter, modifies the three destination trees in the source format, the tree format and the table format. Then, HTML unit 50 updates the three areas of the screen by referring to the three destination trees.

In this manner, a document is displayed on a single screen in a plurality of display formats, thus improving a user's convenience. For example, the user can display and edit a document in a visually easy-to-understand format using the table 90 or the like while understanding the hierarchical structure of the document by the source display or the tree display. In the above example, a single screen is partitioned into a plurality of display formats, and they are displayed simultaneously. Also, a single display format may be displayed on a single screen so that the display format can be switched according to the user's instructions. In this case, the main control unit 22 receives from the user a request for switching the display format and then instructs the respective plug-ins to switch the display.

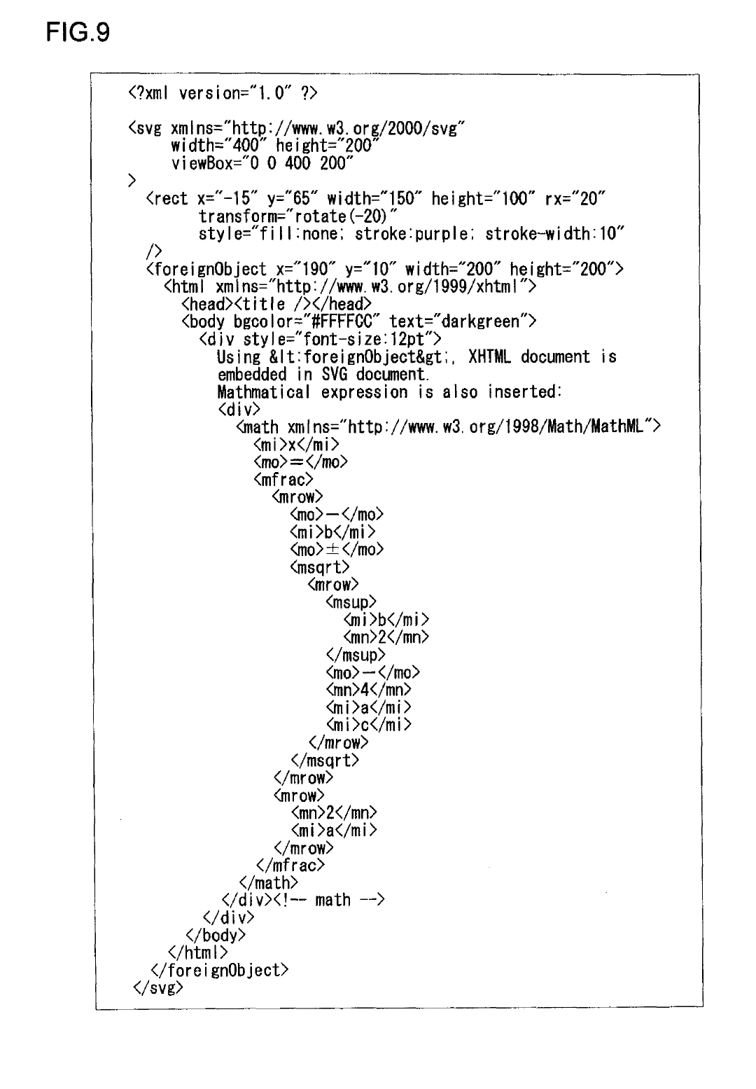

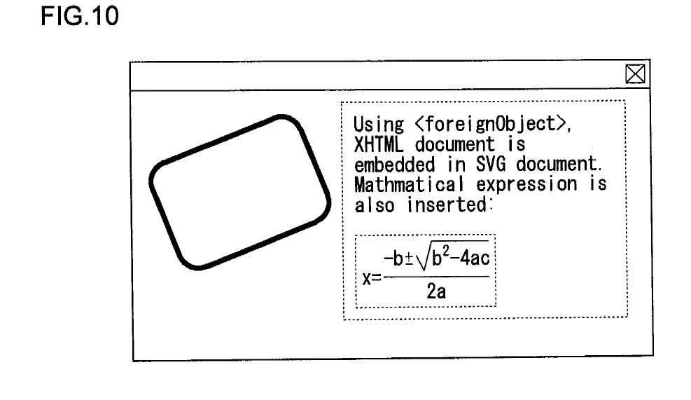

FIG. 9 illustrates another example of an XML document edited by the document processing apparatus 20. In the XML document shown in FIG. 9, an XHTML document is embedded in a “foreignObject” tag of an SVG document, and the XHTML document contains an equation described in MathML. In this case, the editing unit 24 assigns the rendering job to an appropriate display system by referring to the name space . In the example illustrated in FIG. 9, first, the editing unit 24 instructs the SVG unit 60 to render a rectangle, and then instructs HTML unit 50 to render the XHTML document. Furthermore, the editing unit 24 instructs a MathML unit (not shown) to render an equation. In this manner, the compound document containing a plurality of vocabularies is appropriately displayed. FIG. 10 illustrates the resulting display.

The displayed menu may be switched corresponding to the position of the cursor (carriage) during the editing of a document. That is, when the cursor lies in an area where an SVG document is displayed, the menu provided by the SVG unit 60, or a command set which is defined in the definition file for mapping the SVG document, is displayed. On the other hand, when the cursor lies in an area where the XHTML document is displayed, the menu provided by HTML unit 50, or a command set which is defined in the definition file for mapping HTML document, is displayed. Thus, an appropriate user interface can be presented according to the editing position.

In a case that there is neither a plug-in nor a mapping definition file suitable for any one of the vocabularies according to which the compound document has been described, a portion described in this vocabulary may be displayed in source or in tree format. In the conventional practice, when a compound document is to be opened where another document is embedded in a particular document, their contents cannot be displayed without the installation of an application to display the embedded document. According to the Base Technology, however, the XML documents, which are composed of text data, may be displayed in source or in tree format so that the contents of the documents can be ascertained. This is a characteristic of the text-based XML documents or the like.

Another advantageous aspect of the data being described in a text-based language, for example, is that, in a single compound document, a part of the compound document described in a given vocabulary can be used as reference data for another part of the same compound document described in a different vocabulary. Furthermore, when a search is made within the document, a character string embedded in a drawing, such as SVG, may also be search candidates.

In a document described in a particular vocabulary, tags belonging to other vocabularies may be used. Though such an XML document is generally not valid, it can be processed as a valid XML document as long as it is well-formed. In such a case, the tags thus inserted that belong to other vocabularies may be mapped using a definition file. For instance, tags such as “Important” and “Most Important” may be used so as to display a portion surrounding these tags in an emphasized manner, or may be sorted out in the command of importance.

When the user edits a document on an edit screen as shown in FIG. 10, a plug-in or a VC unit 80, which is in charge of processing the edited portion, modifies the source tree. A listener for mutation events can be registered for each Node in the source tree. Normally, a display unit of the plug-in or the VC unit 80 conforming to a vocabulary that belongs to each Node is registered as the listener. When the source tree is modified, the DOM provider 32 traces toward a higher hierarchy from the modified Node. If there is a registered listener, the DOM provider 32 issues a mutation event to the listener. For example, referring to the document shown in FIG. 9, if a Node which lies lower than the <html> Node is modified, the mutation event is notified to HTML unit 50, which is registered as a listener to the <html> Node. At the same time, the mutation event is also notified to the SVG unit 60, which is registered as a listener in an <svg> Node, which lies upper to the <html> Node. At this time, HTML unit 50 updates the display by referring to the modified source tree. Since the Nodes belonging to the vocabulary of the SVG unit 60 itself are not modified, the SVG unit 60 may disregard the mutation event.

Depending on the contents of the editing, modification of the display by HTML unit 50 may change the overall layout. In such a case, the layout is updated by a screen layout management mechanism, e.g., the plug-in that handles the display of the highest Node, in increments of display regions which are displayed according to the respective plug-ins. For example, in a case of expanding a display region managed by HTML unit 50, first, HTML unit 50 renders a part managed by HTML unit 50 itself, and determines the size of the display region. Then, the size of the display area is notified to the component that manages the screen layout so as to request the updating of the layout. Upon receipt of this notice, the component that manages the screen layout rebuilds the layout of the display area for each plug-in. Accordingly, the display of the edited portion is appropriately updated and the overall screen layout is updated.

### EMBODIMENT

In an embodiment, a technology is proposed in which a name of a definition file is automatically created by following a rule, which has been set up, for determining a name of a definition file, even if the definition file is not specified, thereby an appropriate definition file can be made available. In an example shown in FIG. 2, the name of a definition file to be applied to an XML document is described as PI (Processing Instruction). According to the present embodiment, a name of a definition file is automatically created based on a namespace URI reference of a vocabulary included in an XML document. Due to this, an appropriate definition file is made available, even if a name of a definition file is not explicitly specified in a document, or if a correspondence between a document and a definition file is not held in a table or the like.

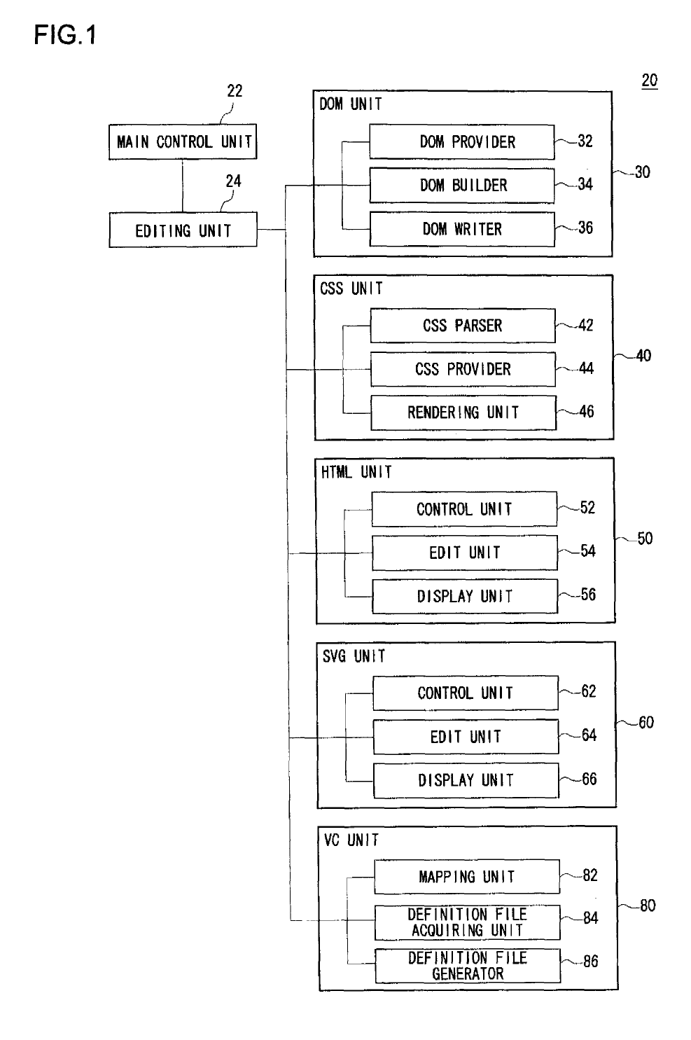

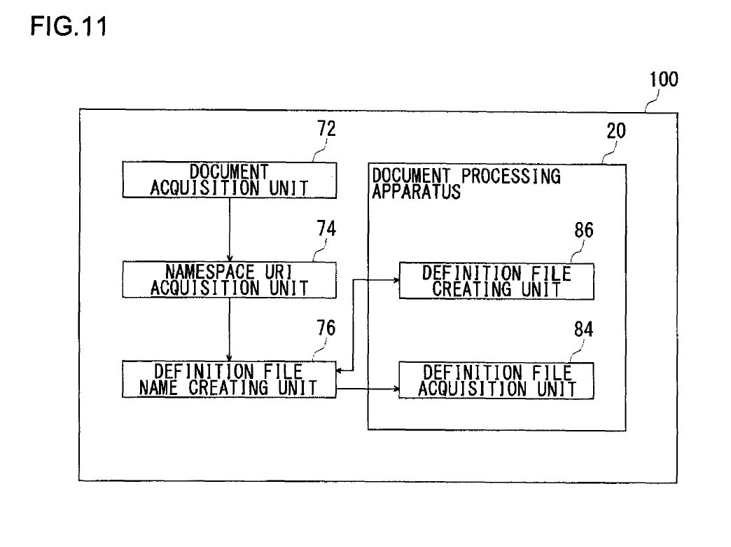

FIG. 11 shows a structure of the document processing apparatus 100 of the present embodiment. The document processing apparatus 100 of the present embodiment includes the document acquisition unit 72, the namespace URI reference acquisition unit 74, and the definition file name creating unit 76, in addition to the structure of the document processing apparatus 20 in the base technology shown in FIG. 1. The document acquisition unit 72 acquires a document to be processed by the document processing apparatus 100. The namespace URI reference acquisition unit 74 acquires a namespace of a vocabulary by which a document acquired is described. The definition file name creating unit 76 creates a name of a definition file based on the namespace URI reference acquired. Other components and operations are the same as that of the base technology.

A namespace URI reference is a character string for identifying a namespace uniquely, and is defined by the RFC2396. In a namespace URI reference, characters, such as “* (asterisk)”, are allowed to be used and the length of a character string is limitless. Accordingly, in a file system where characters, such as “*”, are not allowed to be used as a name of a file, it is not proper to use a namespace URI reference as a name of a definition file as it is, because the definition file cannot be identified. Therefore, in the present embodiment, a character string of a namespace URI reference is converted by a hash function so that a hash value obtained is a name of a definition file. As a hash function, any algorithm, such as MD5 or SHA-1, may be available.

To avoid a collision of hash values, i.e., collision of names of definition files, it is desirable that an address space of a hash value be provided appropriately. If an address space of a hash value is provided with a sufficiently large space, the possibility that different multiple namespace URI references might be converted into an identical hash value, can be reduced actually to zero, therefore a name of a definition file to be applied to a document can be identified uniquely by computing a hash value of a namespace URI reference.

An operation will be mentioned in which the document processing apparatus 100 creates a new definition file. When the definition file creating unit 86 creates a definition file, the definition file name creating unit 76 creates a name of the definition file. When having created a definition file of an existing vocabulary, the definition file creating unit 86 simply notifies the definition file name creating unit 76 of the namespace URI reference of the definition file, and makes the name creating unit create a name of a definition file, because the namespace URI references of the definition file is already available. When creating a new vocabulary by designing a new definition file, the definition file creating unit 86 determines a namespace URI reference of the new vocabulary by inquiring of a user the namespace URI reference and so forth, and then notifies the definition file name creating unit 76 of the namespace URI reference determined to make the name of the definition file created. Alternatively, a namespace URI reference may be created automatically by the definition file creating unit 86 by following a predetermined rule. For example, a namespace URI reference may be created by adding a character string to a domain name which is owned by a user and registered in advance. Alternatively, a namespace URI reference may be created by requesting a server which issues a new namespace URI reference to issue a namespace URI reference. The definition file creating unit 86 stores a definition file created after giving a name, which is communicated by the definition file name creating unit 76, to the definition file.

An operation will then be mentioned in which an XML document is loaded into the document processing apparatus 100. When the document acquisition unit 72 acquires an XML document, the namespace URI reference acquisition unit 74 acquires a namespace URI reference of a vocabulary which is a tag set to which an element included in the XML document belongs. A namespace URI reference is specified in, for example, the tag <marks> on the third line of the document shown in FIG. 2. When the namespace URI reference acquisition unit 74 acquires a namespace URI reference, the definition file name creating unit 76 creates a name of the definition file by computing a hash value of the namespace URI reference. The definition file name creating unit 76 may name the definition file the hash value as it is, or may create a name of the file by performing a further operation on the hash value. The definition file acquisition unit 84 acquires a definition file of which name is created by the definition file name creating unit 76. When a definition file is acquired, an element included in a document is mapped to an element of a vocabulary of XHTML or the like by the mapping unit 82, and displayed and edited by the HTML unit 50 or the like, as explained in the base technology.

In the aforementioned description, a name of a definition file is created from a hash value of a namespace URI reference; however, a name of a definition file may be created from another hash value of another information, for example, a character string obtained by coupling a local name of an apex element in a zone described in a certain vocabulary (tag set), with a namespace URI reference. By doing so, zones of which apex elements have different local names with each other, can be processed by applying different definition files respectively, even if the namespace URI references of the zones are described in the identical vocabulary.

As described above, a name of a definition file which should be applied to an XML document can be created by using a hash value of a character string including a namespace URI reference of a vocabulary by which an XML document is described”. Such a way can convert even a long character string into a certain length of character string and into characters which can be used as a name of a file, while maintaining uniqueness of a file name.

The present invention has been described above in conjunction with the embodiments thereof. The embodiment has been given solely by way of illustration, and it will be understood by a person skilled in the art that various modifications may be made to combinations of the foregoing components and processes, and all such modifications are also intended to fall within the scope of the present invention.

In the embodiment, an example in which an XML document is processed has been mentioned; however, the document processing apparatus 100 of the present embodiment can process a document described in other markup languages, for example, SGML, HTML etc., as well.

### INDUSTRIAL APPLICABILITY

The present invention can be used in a document processing apparatus which processes a document described in a markup language.

1. A document processing apparatus comprising:
an identifier acquisition unit which acquires an identifier for identifying a tag set to which an element included in a document belongs; and
a file name creating unit which creates a name of a file to be associated with a document based on the identifier.

2. The document processing apparatus according to claim 1, wherein the file to be associated with the document is a definition file in which a method for processing the document is described.

3. The document processing apparatus according to claim 2, further comprising: a document acquisition unit which acquires the document; and a definition file acquisition unit which acquires the definition file, wherein the identifier acquisition unit acquires an identifier described in a document which the document acquisition unit acquires, and the definition file acquisition unit acquires the definition file of which name is created by the file name creating unit based on the identifier.

4. The document processing apparatus according to claim 2, further comprising a definition file creating unit which creates the definition file, wherein the definition file creating unit gives a name to the definition file created, a name created by the file name creating unit based on an identifier for identifying a tag set to which an element which is processed by the definition file belongs.

5. The document processing apparatus according to claim 1, wherein the file name creating unit creates a name of the file based on a hash value obtained by converting the identifier with the use of a hash function.

6. A document processing method comprising:
acquiring an identifier for identifying a tag set to which an element which is included in a document belongs; and
creating a name of a file to be associated with the document based on the identifier.

7. A computer program product comprising:
a module which acquires an identifier for identifying a tag set to which an element included in a document belongs; and
a module which creates a name of a file to be associated with the document based on the identifier.
